(19) United States
(12) Patent Application Publication
(10) Pub. No.: US 2026/0000092 A1
(43) Pub. Date: Jan. 1, 2026

(54) Cleanable Slush Machine Cover

(71) Applicant: Cixi City Spring Electric Appliance Co., Ltd., Cixi City (CN)

(72) Inventor: Mengbo Yang, Cixi City (CN)

(73) Assignee: Cixi City Spring Electric Appliance Co., Ltd., Cixi City (CN)

(21) Appl. No.: 19/301,844

(22) Filed: Aug. 15, 2025

(30) Foreign Application Priority Data
Dec. 17, 2024 (CN) 202423109879.1

(51) Int. Cl. A23G 9/22; A23G 9/04; A23G 9/08

(52) U.S. Cl. CPC A23G 9/22; A23G 9/045; A23G 9/08

(57) ABSTRACT

The utility model relates to a slush machine housing that is easy to clean, wherein the housing comprises a discharge outlet, a feed port, an openable feed cover provided on the feed port, and a detachable rear side of the housing comprising a rear cover. An ice column making opening is provided on the rear cover, a sealing ring installation groove is provided on the outer side of the rear cover, and a sealing ring is provided on the sealing ring installation groove. The beneficial effect of the slush machine housing is its easy cleaning. The detachable rear cover of the slush machine housing allows people to clean the inside of the housing more easily and thoroughly, remove dirt and debris, and keep the slush machine clean and hygienic.

### TECHNICAL FIELD

The present disclosure relates to an improvement on the cover structure of a slush machine.

### BACKGROUND

As a specialty ice dessert product, shaved ice, slush or ‘slushie’ has gradually become popular in recent years, and the corresponding slush machine has also been continuously developed and improved with market demand. Its origin may be inspired by traditional ice product making processes, but combined with modern machinery manufacturing and refrigeration technology, it has gradually evolved into today's slush machines.

The slush machine consists of two parts: an ice-making structure and a refrigeration unit. The ice-making structure includes an refrigerated ice-making column, wherein the ice-making column is cooled by the refrigerator unit, and a spiral scraper is provided outside the ice-making column to scrape the ice layer outside the ice-making column to provide slush to a discharging mechanism for users to use.

The cover of the ice-making refrigerators should be cleaned frequently when in use, and, despite the need for frequent cleanings, they are not easy to disassemble and clean.

### SUMMARY

In order to overcome the shortcomings of the current slush machine covers that are difficult to disassemble and clean, have poor sealing, and frequently leak sugar solution, a frozen ice dessert machine housing cover structure is disclosed that is highly functional and easy to clean.

The technical solution of the aforementioned problems is: an easily-cleaned slush machine housing, wherein the housing is provided with a discharge outlet, the upper side of the housing is a feed port, the feed port is provided with an openable feed cover, the rear of the housing is open, and the open rear side of the housing is provided with a removable rear cover, wherein an ice column opening is provided on the rear cover, an outer surface of the rear cover is provided with a sealing ring installation groove, the front side of the sealing ring installation groove is a front convex edge, the rear side of the sealing ring installation groove is a flange, the sealing ring installation groove is provided with a sealing ring, the outer side of the sealing ring is provided with a sealing lip, and the sealing lip abuts the rear side opening wall of the slush machine housing when the rear cover is installed.

In order to increase the sealing performance, two sealing lips of the sealing ring are provided side by side.

In order to prevent the syrup from overflowing, a trough for guiding the syrup to be poured is provided at the feed inlet, and a trough outlet is provided at the lowest end of the trough.

In order to facilitate disassembly and cleaning, the trough is arranged on a detachable box, and the box is installed on the feed inlet.

In one preferred embodiment, the trough comprises a level bottom surface, one end of the bottom surface is high and the other end is low, and the low end is close to the rear side of the cover shell.

In another preferred embodiment, the trough is provided with two V-shaped walls, and the trough outlet is opened between the two walls of the trough.

In another preferred embodiment, one side of the feed cover is pivotally connected to the cover shell, and the feed cover is rotated to open.

In order to ensure the feed cover is firmly covered, a hook is provided on the side of the feed cover, and the hook hooks the feed inlet.

In order to reduce the weight of the rear cover, a protrusion is provided on the rear edge of the rear cover, and the rest of the cover surface is sunken to form a weight-reducing cavity.

The benefit of the disclosed housing is that users can conveniently remove the rear cover from the housing when cleaning, because the cover is connected to the housing by the elastic force of the sealing ring, so it is very convenient to remove. At the same time, after removing the cover, the structure inside the housing is clearly visible, and it is very convenient to clean.

The beneficial effects of the utility model are: 1. Easy cleaning is its significant advantage. The detachable cover can make it easier and more thorough to clean the inside of the housing, remove dirt and debris, and keep the slush machine clean and hygienic. 2. Convenient maintenance. When the components inside the housing fail or need maintenance, the cover can be removed for direct operation, saving maintenance time and cost. 3. The cover can be removed at any time to check the inside of the housing, discover potential problems in a timely manner, and prevent failures.

### BRIEF DESCRIPTION OF THE DRAWINGS

FIG. 1 is a schematic diagram of an embodiment of the housing.

FIG. 2 is a schematic diagram of an exploded view of an embodiment of the housing.

FIG. 3 is a schematic diagram of an exploded view of another embodiment.

FIG. 4 is a schematic diagram of a rearward exploded view of another embodiment.

FIG. 5 is a schematic diagram of an exploded view of the rear cover of the housing.

FIG. 6 is a partial cross-sectional view of the rear cover in position.

### DETAILED DESCRIPTION OF EMBODIMENTS

The utility model is further described in detail below in conjunction with the embodiments of the accompanying drawings.

### Embodiment 1

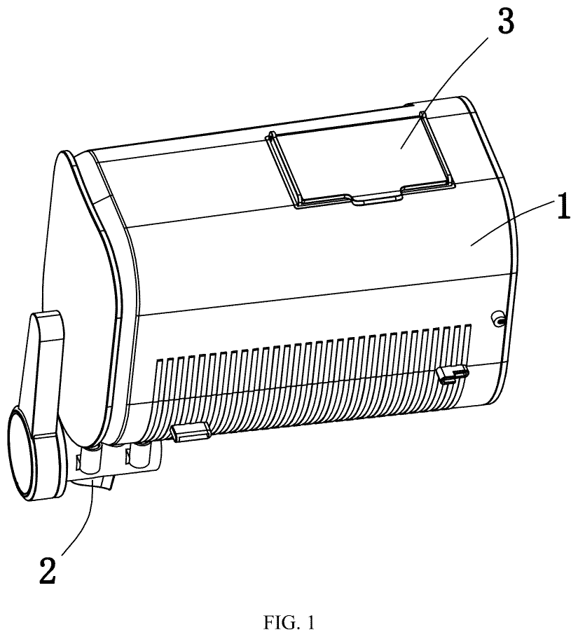

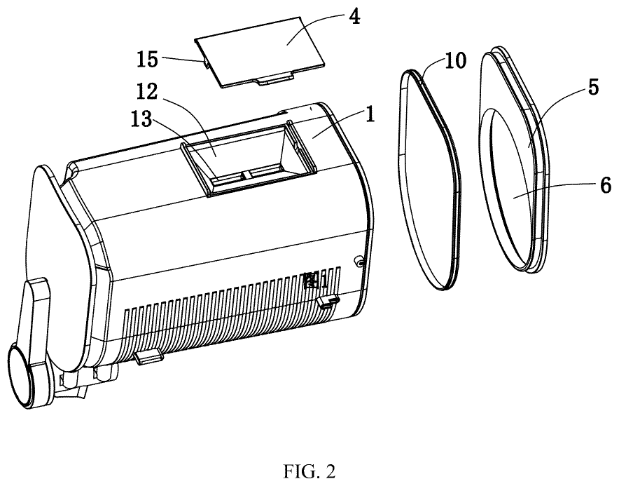

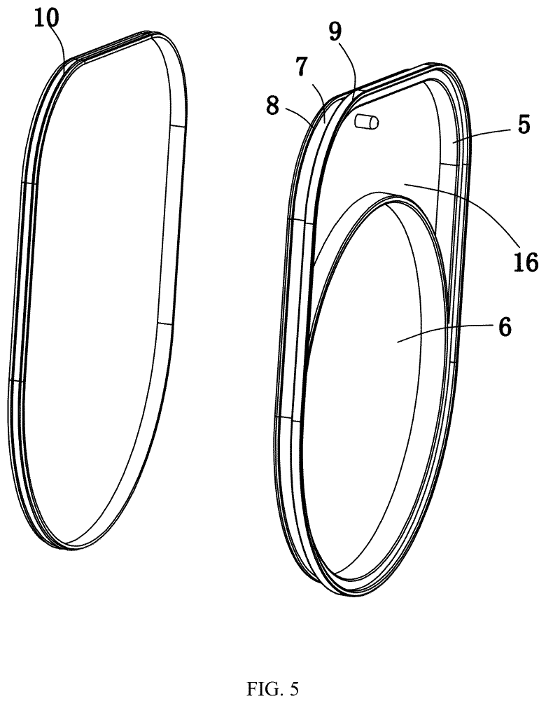

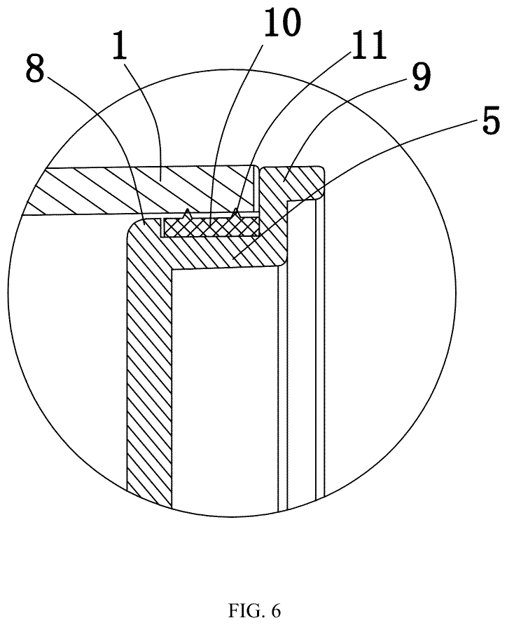

In conjunction with FIGS. 1, 2, 5, and 6, a slush machine housing structure that is easy to clean includes a housing 1, a discharging tap 2 is provided on the housing 1, a feed port 3 is provided on the upper side of the housing 1, and a feed cover 4 that can be opened is provided at the feed port 3, the rear side of the housing 1 is open, a rear cover 5 is provided at the rear opening of the housing 1, an ice column opening 6 is provided on the rear cover 5, a sealing ring installation groove 7 is provided on the outer side of the rear cover 5, a front convex edge 8 is provided on the front side of the sealing ring installation groove 7, a flange 9 is provided on the rear side of the sealing ring installation groove 7, a sealing ring 10 is provided on the outer side of the sealing ring 10, and a sealing lip 11 is provided on the outer side of the sealing ring 10, and the sealing lip 11 makes contact against the rear opening wall of the housing.

In order to increase the sealing performance, two sealing lips 11 of the sealing ring 10 are provided side by side.

To prevent the syrup from overflowing, a trough 12 for guiding the syrup to be poured is provided at the feed port 3, and an outlet opening 13 is provided at the bottom of the trough 12.

In another preferred embodiment, the trough 12 is provided with two V-shaped walls, and the outlet opening 13 is opened between the two walls of the trough 12.

The feed cover 4 is preferably selected, and one side of the feed cover 4 is pivotally connected to the cover shell 1, and the feed cover 4 is rotated to open.

In order to ensure that the feed cover 4 is firmly covered, a hook 15 is provided on the side of the feed cover 4, and the hook 15 hooks the feed port 3.

In order to reduce the weight of the rear cover 5, a protrusion is provided on the rear edge of the rear cover 5, and the rest of the cover surface is sunken to form a weight-reducing cavity 16.

The rear cover 5 can conveniently be removed from the housing 1 when cleaning, because the rear cover 5 is elastically clamped on the housing 1 by the sealing ring 10, so it is very convenient to remove. At the same time, after removing the rear cover 5, the structure inside the housing 1 is clearly visible, and it is very convenient to clean.

### Embodiment 2

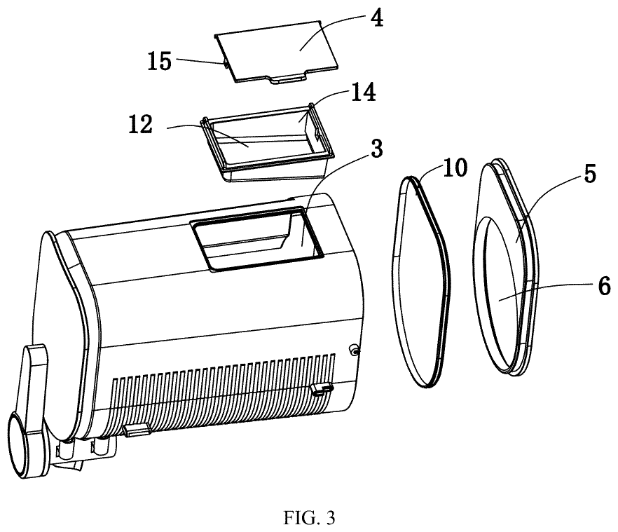

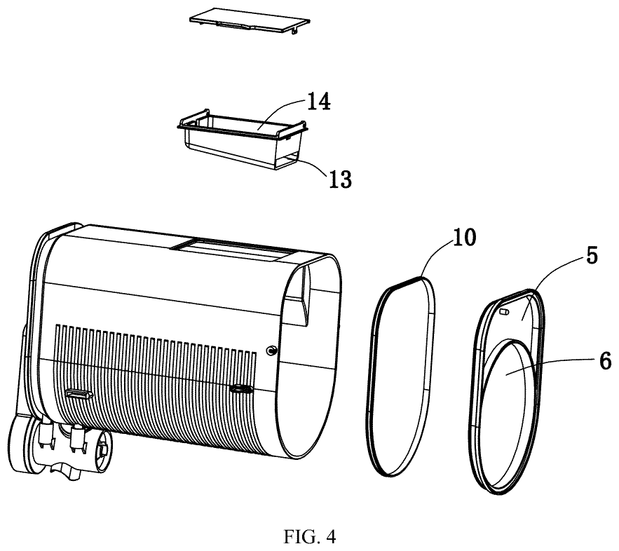

Combined with FIGS. 1 and 3 to 6, a slush machine housing structure that is easy to clean includes a housing 1, a discharging tap 2 is provided on the housing 1, a feed port 3 is provided on the upper side of the housing 1, a feed cover 4 that can be opened is provided at the feed port 3, the rear side of the housing 1 is open, a rear cover 5 is provided at the rear opening of the housing 1, an ice column opening 6 is provided on the rear cover 5, a sealing ring installation groove 7 is provided on the outer side of the rear cover 5, a front convex edge 8 is provided on the front side of the sealing ring installation groove 7, a flange 9 is provided on the rear side of the sealing ring installation groove 7, a sealing ring 10 is provided on the outer side of the sealing ring 10, a sealing lip 11 is provided on the outer side of the sealing ring 10, and the sealing lip 11 is against the rear opening wall of the housing. In order to increase the sealing performance, two sealing lips 11 of the sealing ring 10 are provided side by side.

To prevent the syrup from overflowing, a trough 12 for guiding the syrup to be poured is provided at the feed port 3, and a trough outlet 13 is provided at the lowest end of the trough 12.

For easy disassembly and cleaning, the trough 12 is provided on a detachable guide box 14, and the guide box is installed on the feed port 3.

In a preferred embodiment, the trough 12 is a bottom surface, one end of the bottom surface is high and the other end is low, and the low end is close to the rear side of the cover shell 1.

The feed cover 4 is preferably selected, one side of the feed cover 4 is pivotally connected to the cover shell 1, and the feed cover 4 is rotated to open.

In order to ensure that the feed cover 4 is firmly covered, a hook 15 is provided on the side of the feed cover 4, and the hook 15 hooks the feed port 3.

In order to reduce the weight of the rear cover 5, a protrusion is provided on the rear edge of the rear cover 5, and the rest of the cover surface is sunken to form a weight reduction cavity 16.

The utility model can conveniently remove the rear cover 5 from the housing 1 when in use, because the rear cover 5 is elastically clamped on the housing 1 by the sealing ring 10, so it is very convenient to remove. At the same time, after removing the rear cover 5, the structure inside the housing 1 is clearly visible, and it is very convenient to clean.

The beneficial effects of the utility model are: 1. Easy cleaning is its significant advantage. The detachable cover can make it easier and more thorough to clean the inside of the housing, remove dirt and debris, and keep the slush machine clean and hygienic. 2. Convenient maintenance. When the components inside the housing fail or need maintenance, the cover can be removed to access the machine directly, saving maintenance time and cost. 3. The cover can be removed at any time to check the inside of the housing, discover potential problems in a timely manner, and prevent failures.

What is claimed is:

1. A slush machine housing structure comprising:
a housing, a discharge outlet provided on the housing, a feed port provided on an upper side of the housing, and an openable feed cover on the feed port, wherein:
the housing comprises a rear opening, and a removable rear cover is provided at the rear opening of the housing, wherein an ice column opening is provided through the rear cover, a sealing ring installation groove is provided on an outer edge of the rear cover, a front side of the sealing ring installation groove is a front convex edge, a rear side of the sealing ring installation groove is a flange;
wherein the rear cover further comprises a sealing ring provided in the sealing ring installation groove, wherein a sealing lip is provided on an outer side of the sealing ring, and wherein the sealing lip abuts the rear opening wall of the housing.

2. The slush machine housing structure according to claim 1, characterized in that: two sealing lips of the sealing ring are provided side by side.

3. The slush machine housing structure according to claim 1, characterized in that: the feed port comprises a trough for guiding the pouring of syrup, and a trough outlet is provided at a low end of the trough.

4. The slush machine housing structure according to claim 3, characterized in that: the trough is arranged on a detachable box, and the detachable box is installed on the feed port.

5. The slush machine housing structure according to claim 3, characterized in that: the trough comprises a flat bottom surface, one end of the flat bottom surface is high and the other end is low, and the low end is close to the rear side of the housing.

6. The slush machine housing structure according to claim 3, characterized in that: the trough is provided with V-shaped side walls, and the trough outlet is positioned between the V-shaped side walls.

7. The slush machine housing structure according to claim 1, characterized in that: one side of the feed cover is pivotally connected to the housing, and the feed cover can be rotated to open.

8. The slush machine housing structure according to claim 1, characterized in that: the side of the feed cover is provided with a hook, and the hook is capable of engaging the feed port.

9. The slush machine housing structure according to claim 1, characterized in that: the rear edge of the rear cover is provided with a protrusion, and the rest of the rear cover surface is sunken to form a weight-reducing cavity.
